(19) United States
(12) Patent Application Publication
(10) Pub. No.: US 2026/0247271 A1
(43) Pub. Date: Aug. 20, 2026

(54) COMMUNICATION METHOD, TERMINAL, CORE NETWORK DEVICE, COMMUNICATION SYSTEM, AND STORAGE MEDIUM

(71) Applicant: Beijing Xiaomi Mobile Software Co., Ltd., Beijing (CN)

(72) Inventors: Xinli WANG, Beijing (CN); Yang SHEN, Beijing (CN)

(21) Appl. No.: 19/489,510

(22) PCT Filed: Jun. 2, 2023
(86) PCT No.: PCT/CN2023/098149

§ 371 Date: Dec. 2, 2025

(51) Int. Cl. H04W 48/18; H04W 8/24; H04W 76/27

(52) U.S. Cl. CPC H04W 48/18; H04W 8/24; H04W 76/27

(57) ABSTRACT

A communication method, including: sending a first request, where the first request is configured to request a core network device to associate with a user equipment (UE), the UE has a sensing capability, and the UE associated with the core network device is configured to perform a sensing service.

### CROSS-REFERENCE TO RELATED APPLICATIONS

The present application is a U.S. National Stage of International Application No. PCT/CN2023/098149, filed on Jun. 2, 2023, the contents of all of which are incorporated herein by reference in their entirety for all purposes.

### BACKGROUND OF THE INVENTION

A sensing service refers to a service in which a sensing-capable device is able to obtain sensing information about a target object and its characteristics without contacting the target object. Furthermore, a distance, an angle, a velocity, and other data of the target object can be sensed based on the sensing information.

### SUMMARY OF THE INVENTION

The present disclosure relates to the technical field of communication, and particularly relates to a communication method and a user equipment.

The present disclosure provides a communication method and a user equipment.

A first aspect of embodiments of the present disclosure provides a communication method, performed by user equipment (UE). The method includes sending a first request, where the first request is configured to request a core network device to associate with the UE, the UE has a sensing capability, and the UE associated with the core network device is configured to perform a sensing service.

A second aspect of embodiments of the present disclosure provides a communication method, performed by a core network device. The method includes receiving a first request, where the first request is configured to request the core network device to associate with a UE, the UE has a sensing capability, and the UE associated with the core network device is configured to perform a sensing service.

A third aspect of embodiments of the present disclosure provides a communication method, performed by a first network element. The method includes receiving a first request and forwarding the first request to a second network element, where the first request is configured to request a core network device to associate with a UE, the UE has a sensing capability, and the UE associated with the core network device is configured to perform a sensing service.

A fourth aspect of embodiments of the present disclosure provides a UE. The UE includes one or more processors; and a memory configured to store processor-executable instructions, where the processor-executable instructions, when collectively executed by the one or more processors, cause the UE to perform the method according to the first aspect.

It should be understood that the above general description and the following detailed description are merely illustrative and explanatory, and do not limit the present disclosure.

### BRIEF DESCRIPTION OF DRAWINGS

The accompanying drawings here, incorporated in the description as a constituent part of the description, illustrate embodiments conforming to the present disclosure, and serve to describe the principles of the present disclosure together with the description.

FIG. 1 is a schematic diagram of a communication system according to an example.

FIG. 2 is a flowchart of a communication method according to an example.

FIG. 3 is a flowchart of a communication method according to an example.

FIG. 4 is a flowchart of a communication method according to an example.

FIG. 5 is a flowchart of a communication method according to an example.

FIG. 6 is a flowchart of a communication method according to an example.

FIG. 7 is a flowchart of a communication method according to an example.

FIG. 8 is a flowchart of a communication method according to an example.

FIG. 9 is a flowchart of a communication method according to an example.

FIG. 10 is a flowchart of a communication method according to an example.

FIG. 11 is a flowchart of a communication method according to an example.

FIG. 12 is a flowchart of a communication method according to an example.

FIG. 13 is a flowchart of a communication method according to an example.

FIG. 14 is a flowchart of a communication method according to an example.

FIG. 15 is a flowchart of a communication method according to an example.

FIG. 16 is a flowchart of a communication method according to an example.

FIG. 17 is a flowchart of a communication method according to an example.

FIG. 18 is a flowchart of a communication method according to an example.

FIG. 19 is a flowchart of a communication method according to an example.

FIG. 20 is a flowchart of a communication method according to an example.

FIG. 21 is a flowchart of a communication method according to an example.

FIG. 22 is a flowchart of a communication method according to an example.

FIG. 23 is a flowchart of a communication method according to an example.

FIG. 24 is a flowchart of a communication method according to an example.

FIG. 25 is a block diagram of a user equipment according to an example.

FIG. 26 is a block diagram of a core network device according to an example.

FIG. 27 is a block diagram of a first network element according to an example.

FIG. 28 is a block diagram of a second network element according to an example.

FIG. 29 is a block diagram of a structure of a terminal according to an example.

FIG. 30 is a block diagram of a structure of a core network device according to an example.

### DETAILED DESCRIPTION OF THE INVENTION

Examples are described in detail here and illustrated in the accompanying drawings. In a case where the following description involves the accompanying drawings, unless otherwise specified, an identical number in different accompanying drawings denotes identical or similar elements. Implementations described in the following examples do not represent all implementations consistent with the present disclosure.

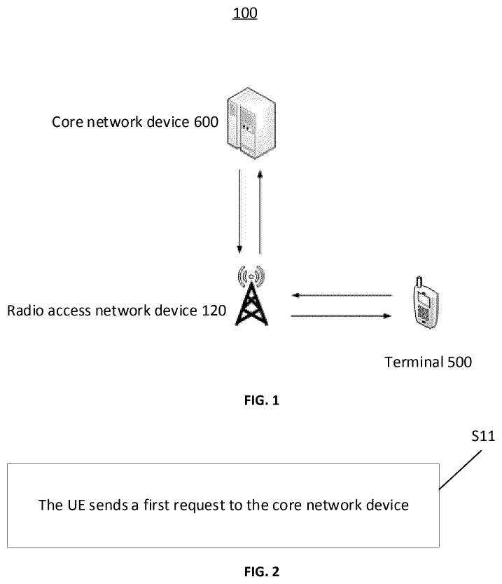

A communication method provided by embodiments of the present disclosure may be applied to a wireless communication system 100 shown in FIG. 1. As shown in FIG. 1, a terminal 500 accesses a radio access network via a radio access network device 120, such as a base station. The radio access network device 120 and the core network device 600 complete data backhaul and forward transmission to perform various communication services.

It may be understood that the wireless communication system is a network configured to provide a wireless communication function. The wireless communication system may use different communication technologies, such as code division multiple access (CDMA), wideband code division multiple access (WCDMA), time division multiple access (TDMA), frequency division multiple access (FDMA), orthogonal frequency-division multiple access (OFDMA), single carrier FDMA (SC-FDMA), and carrier sense multiple access with collision avoidance. Based on capacities, rates, delays, and other factors of different networks, networks may be divided into 2nd generation (2G), 3G, 4G, or future-evolved networks, such as 5G networks. 5G networks may also be referred to as new radio (NR). For convenience of description, in some cases, a wireless communication network is referred to as a network or a system for short in the present disclosure. In the present disclosure, the network may include a radio access network (RAN) and a core network (CN). The network includes a network device. The network device may be a radio access network node, a core network function, etc. The radio access network node may also be referred to as a base station. The network may provide a network service for the terminal via the network device. Different operators may provide different network services for the terminal. It may also be understood that different operators correspond to different operator networks.

The terminal may also be referred to as a user equipment (UE), a mobile station (MS), a mobile terminal (MT), etc., and is a device configured to provide at least one of voice or data connectivity to a user. For example, the terminal may be a handheld device with a wireless connection function, a vehicular device, etc. At present, some terminals include, for example, a mobile phone, a pocket personal computer (PPC), a handheld computer, a personal digital assistant (PDA), a notebook computer, a tablet computer, a wearable device, or a vehicular device.

A core network device may be one device, including a first network element, a second network element, etc., or a plurality of devices or a group of devices, each including all or some of a first network element, a second network element, etc. The network elements may be virtual or physical. For example, the core network includes at least one of an evolved packet core (EPC), a 5G core network (5GCN), or a next generation core (NGC). For example, the core network device includes a session management function (SMF) network element, an access and mobility management function (AMF) network element, a radio access network (RAN), a unified data management (UDM) network element, a policy control function (PCF) network element, and a user plane function (UPF) network element. Clearly, the core network function also includes other types of devices that are not listed in the embodiments of the present disclosure.

A sensing service uses a sensing-capable device to obtain sensing information about a target object and its characteristics without contacting the target object, and further senses a distance, an angle, a velocity, and other data of the target object based on the sensing information. For example, radar (radio detection and ranging) is a widely used wireless sensing technology that determines a distance (range), an angle, or an instantaneous linear velocity of an object based on radio waves. At present, there are some sensing technologies based on non-radio frequency sensors, such as a time-of-flight (ToF) camera, an accelerometer, a gyroscope, and lidar.

In the related art, integrated communication and sensing is provided. It means that a sensing capability is provided by an NR wireless communication system and infrastructure, which are configured for communication, and that sensing information may be obtained from at least one of a radio-frequency-based sensor or a non-radio-frequency-based sensor. For example, in a case where sensing information related to a communication channel or an environment is configured to improve the communication service of a communication system itself, the sensing information may assist with radio resource management, interference mitigation, beam management, mobility, etc.

At present, the integrated communication and sensing includes communication-assisted sensing and sensing-assisted communication scenarios.

Communication-assisted sensing means that a wireless signal is configured to perform sensing while communication is performed based on the wireless signal, to obtain sensing information. For example, application scenarios of the communication-assisted sensing include, but are not limited to, the following scenarios:
A. Environment Real-time monitoring: using a wireless signal to reconstruct an environment map to improve positioning accuracy further, and to realize an array of real-time monitoring-related applications, such as dynamic three-dimensional (3D) maps for driving assistance, pedestrian flow statistics, intrusion detection, traffic detection, etc.
B. Autonomous vehicles/unmanned aerial vehicles: sensing is performed based on a wireless signal to avoid an obstacle. Meanwhile, autonomous vehicles/unmanned aerial vehicles should have the capability to sense path information, such as selecting a route and complying with traffic regulations.
C. Air pollution monitoring: based on the quality of a received wireless signal, different attenuation characteristics with changes in air humidity, air particulate matter (PM) concentration, carrier frequency, and other parameters may be determined, and the attenuation characteristics may be configured for weather detection or air quality detection.
D. Indoor health care and intrusion detection: respiratory rate estimation, breathing depth estimation, apnea detection, vital sign monitoring of the elders, and indoor intrusion detection may be implemented.

Sensing-assisted communication means sensing the wireless communication channel and the environment, to obtain the sensing information, and further to improve the performance of a communication system based on the sensing information. For example, application scenarios of the sensing-assisted communication include, but are not limited to, the following scenarios:
A. Sensing a location and a channel environment of the UE to narrow a beam scanning range and shorten beam training time.
B. Sensing a location, a velocity, a trajectory, and a channel environment of the UE for beam prediction, and reducing the overhead of beam measurement and the delay of beam tracking.
C. Sensing the property and the channel environment of the UE to improve the performance of channel estimation.

Based on the above description, the integrated communication and sensing means that information such as an orientation, a distance, and a velocity can be sensed while information is transmitted, and a target device or an event is detected, tracked, and identified. The communication system and the sensing system are complementary, improving overall performance and delivering a better service experience.

In the related art, the integrated communication and sensing is mainly implemented via a sensing-capable UE.

However, at present, how to determine the sensing-capable UE is a problem that needs to be solved.

Accordingly, the embodiment of the present disclosure provides a communication method. The UE requests the core network device to associate with the UE. After the core network device successfully associates with the UE, because the UE has sensing capability, the core network device can quickly search for the sensing-capable UE when the sensing service is needed later. In this way, search time can be reduced, and sensing efficiency can be improved.

FIG. 2 is a flowchart of a communication method according to an example. As shown in FIG. 2, the communication method is performed by the UE. The communication method includes the following step S11.

In step S11, the UE sends a first request to the core network device.

In some embodiments, the first request is configured to request the core network device to associate with the UE.

In some embodiments, association of the core network device with the UE may be understood as that the UE is registered in the core network device. In this way, the core network device records related information of the UE, such that the core network device can quickly determine the sensing-capable UE later.

In some embodiments, the UE associated with the core network device is configured to perform a sensing service.

In the embodiment of the present disclosure, the UE requests the core network device to associate with the UE. After the core network device successfully associates with the UE, because the UE has sensing capability, the core network device can quickly search for the sensing-capable UE when the sensing service is needed later. In this way, search time can be reduced, and sensing efficiency can be improved.

In some embodiments of the communication method according to the present disclosure, the first request is carried in an uplink non-access stratum transport (UL NAS TRANSPORT) message. Clearly, the first request may also be carried in other messages, which is illustratively described in the embodiment of the present disclosure.

In some embodiments of the communication method according to the present disclosure, the UE sending the first request has the sensing capability.

In some embodiments, the sensing capability of the UE includes at least one of a 3rd generation partnership project (3GPP) sensing capability or a non-3GPP sensing capability.

In one implementation, the 3GPP sensing capability indicates that the UE performs the sensing service via a wireless signal and other modes under 3GPP to obtain sensing information. In one implementation, the non-3GPP sensing capability indicates that the UE obtains the sensing information based on an infrared sensor, a gyroscope, an acceleration sensor, and other devices.

In some embodiments, the sensing capability of the UE is configured to indicate a sensing mode supported by the UE and a transceiving capability of the UE when performing the sensing service.

In one implementation, the sensing mode includes at least one of the following: performing a sensing service between UEs; performing a sensing service between the UE and a network device; or performing a sensing service between network devices.

In one implementation, the transceiving capability of the UE when performing the sensing service includes determining the UE as a transmitter or a receiver.

For example, the sensing capability of the UE is configured to indicate that the sensing mode supported by the UE is performing the sensing service between the UEs, and the UE sending the first request is determined as the transmitter when performing the sensing service.

In the communication method according to the embodiment of the present disclosure, the first request carries at least one of the following: A, B, C, or D.
A. an association reason.
B. the sensing capability of the UE.
C. location information of the UE.
D. a second routing identifier.

In an example, the first request carries the association reason. The association reason is configured to indicate that the UE and the core network device perform an initial association or an association update.

For example, the UE and the core network device performing the initial association means that the UE accesses a public land mobile network (PLMN) for the first time and sends the first request for the first time; or the UE has already accessed the PLMN but sends the first request for the first time.

For example, the UE and the core network device performing the association update means that the UE has accessed the PLMN, the UE has associated with the core network device, and the state information of the UE has been changed. In this case, the UE needs to resend the first request to update the association between the core network device and the UE. In this way, the core network device can update related information of the UE, such that the core network device can accurately determine the sensing-capable UE later.

In one implementation, the state information of the UE may include at least one of: a continued availability of the UE, the location information of the UE, or the sensing capability of the UE. Optionally, the continued availability of the UE may indicate that the UE can perform the sensing service within a specific time period. In a case where an available time period of the UE is updated, that is, the time period during which the UE performs the sensing service changes, the UE needs to resend the first request to request the update of the association with the core network device. In this way, the situation where the core network device cannot select the correct UE to perform the sensing service according to the continued availability of the UE due to a change in the time period during which the UE performs the sensing service can be avoided. Optionally, the location information of the UE indicates a current location, a direction, and other information of the UE. In a case where the location information of the UE changes, the association between the UE and the core network device needs to be updated, and the situation where the core network device cannot select the correct UE to perform the sensing service according to the location information of the UE due to a change in the location information of the UE can be avoided.

In another example, the first request carries the sensing capability of the UE. It is worth noting that the sensing capability of the UE carried in the first request is a sensing capability of the UE determined by the UE itself. For example, the sensing capability of the UE is a 3GPP sensing capability; the sensing mode supported by the UE is that the sensing service is performed between UEs, and the UE that sends the first request is determined as the receiver when performing the sensing service.

In another example, the first request carries the location information of the UE. In one implementation, in a case where the UE stores the location information, the first request may carry the location information, such that the core network device can accurately determine a location of the UE. In another implementation, in a case where the UE does not store the location information, the first request may not carry the location information.

In another example, the first request carries the second routing identifier. The second routing identifier is configured to indicate the core network device associated with the UE. In some embodiments, the core network device associated with the UE may be referred to as a serving core network device for the UE. It may be understood that the second routing identifiers between different UEs and core network devices are different or the same.

In another example, the first request carries the association reason and the sensing capability of the UE.

In another example, in a case where the UE stores the location information, the first request carries the association reason, the sensing capability of the UE, and the location information of the UE.

In another example, in a case where the UE stores the second routing identifier, the first request carries the association reason, the sensing capability of the UE, and the second routing identifier.

In another example, in a case where the UE stores the location information and the second routing identifier, the first request carries the association reason, the sensing capability of the UE, the location information of the UE, and the second routing identifier.

In the embodiment of the present disclosure, the UE sends the first request, such that the core network device can obtain information carried in the first request, and the information can be stored in the core network device. In this way, the core network device can accurately search for a device for performing the sensing service.

In a communication method according to the embodiment of the present disclosure, in a case where an interface between the UE and the core network device is in an idle state, the UE needs to trigger the interface between the UE and the core network device to switch to a connected state.

In an example, the UE sends a second request to trigger the interface between the UE and the core network device to switch to the connected state.

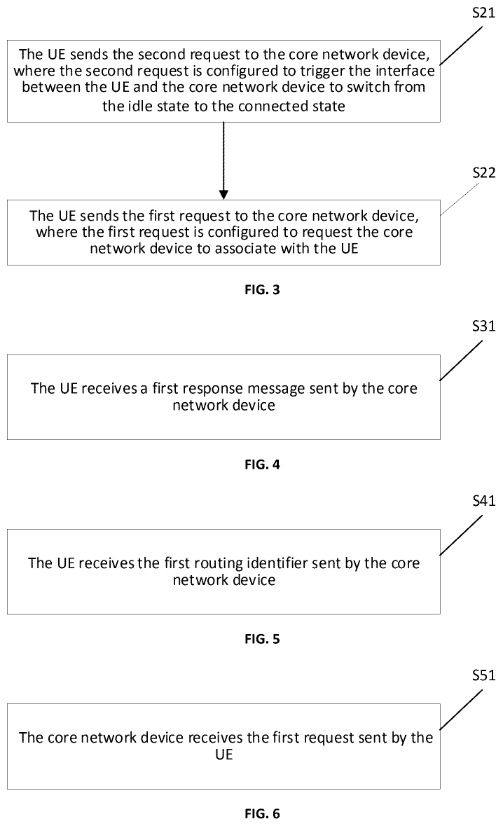

In another example, the UE sends the second request to trigger the interface between the UE and the core network device to switch to the connected state. Then, the first request is sent to request the core network device to associate with the UE. As shown in FIG. 3, FIG. 3 is a flowchart of a communication method according to an example. The communication method includes the following steps: S21 and S22.

In step S21, the UE sends the second request to the core network device, where the second request is configured to trigger the interface between the UE and the core network device to switch from the idle state to the connected state.

In step S22, the UE sends the first request to the core network device, where the first request is configured to request the core network device to associate with the UE.

In the embodiment of the present disclosure, in a case where the interface between the UE and the core network device is in the idle state, the UE needs to trigger the interface to switch to the connected state. In this way, the UE can send data to the core network device later.

In the communication method according to the embodiment of the present disclosure, the UE needs to determine whether the core network device successfully associates with the UE. As shown in FIG. 4, FIG. 4 is a flowchart of a communication method according to an example. The method includes the following step S31.

In step S31, the UE receives a first response message sent by the core network device.

In some embodiments, the first response message is configured to indicate that the core network device successfully associates with the UE.

In some embodiments, the first response message is configured to indicate that the core network device fails to associate with the UE.

In some embodiments, the first response message is carried in a downlink non-access stratum transport (DL NAS TRANSPORT) message.

It should be noted that step S31 may be implemented independently or together with any embodiment of the present disclosure, which is not repeated here. For example, after sending the first request, the UE receives the first response message. For example, the UE sends a second request, triggers the interface between the UE and the core network device to switch to the connected state, sends the first request, and receives the first response message.

In the communication method according to the embodiment of the present disclosure, the first response message is determined based on a verification result of verifying the first request by the core network device. The verification result indicates whether verification of the first request by the core network device is passed.

In an example, in a case where the verification result indicates that verification of the first request by the core network device is passed, the first response message indicates that the core network device successfully associates with the UE.

In an example, in a case where the verification result indicates that verification of the first request by the core network device is not passed, the first response message indicates that the core network device fails to associate with the UE.

In the communication method according to the embodiment of the present disclosure, the verification result is determined based on at least one of subscription information or a preset rule.

In some embodiments, the sensing capability of the UE is stored in the subscription information. The subscription information is configured to verify whether the sensing capability of the UE is correct.

In one implementation, the sensing capability of the UE stored in the subscription information is identical to the sensing capability of the UE included in the first request, indicating that the sensing capability of the UE is correct. The sensing capability of the UE stored in the subscription information is different from the sensing capability of the UE included in the first request, indicating that the sensing capability of the UE is incorrect.

In some embodiments, the preset rule is configured for the core network device to determine whether the core network device accepts association with the UE. In one implementation, the core network device determines a second response message based on the preset rule. The second response message is configured to indicate whether the core network device accepts association with the UE.

In an example, the preset rule includes whether the core network device receiving the first request is a serving core network device for the UE. For example, in a case where the core network device is not the serving core network device corresponding to the UE, the core network device cannot accept the association with the UE. The preset rule is configured to determine that the core network device cannot accept the association with the UE.

In an example, the preset rule includes whether a current load of the core network device can accept association with the UE. For example, in a case where the current load of the core network device is too high to accept the association of the core network device with the UE, the preset rule is configured to determine that the core network device cannot accept the association with the UE.

In an example, in a case where the subscription information verifies that the sensing capability of the UE is correct and the preset rule is configured to determine that the core network device accepts association with the UE, the verification result indicates that verification of the first request by the core network device is passed.

In an example, in a case where the subscription information verifies that the sensing capability of the UE is incorrect and the preset rule is configured to determine that the core network device does not accept association with the UE, the verification result indicates that verification of the first request by the core network device is not passed.

In an example, in a case where the subscription information verifies that the sensing capability of the UE is incorrect, regardless of whether the core network device determines, based on the preset rule, that the core network device accepts the association with the UE, the verification result indicates that verification of the first request by the core network device is not passed.

In an example, in a case where the preset rule is configured to determine that the core network device does not accept the association with the UE, regardless of whether the subscription information verifies that the sensing capability of the UE is correct, the verification result indicates that verification of the first request by the core network device is not passed.

In the embodiment of the present disclosure, the core network device verifies the first request and sends the first response message to the UE based on the verification result. In this way, the UE determines, based on the first response message, whether the core network device successfully associates with the UE, thereby preventing the UE from repeatedly sending the first request and reducing signaling consumption.

In the communication method according to the embodiment of the present disclosure, the UE may receive a first routing identifier sent by the core network device, and the UE may determine the core network device associated with the UE based on the first routing identifier.

FIG. 5 is a flowchart of a communication method according to an example. As shown in FIG. 5, the communication method is performed by the UE. The method includes the following step S41.

In step S41, the UE receives the first routing identifier sent by the core network device.

In some embodiments, the first routing identifier is carried in the DL NAS TRANSPORT message.

In some embodiments, the first routing identifier and the second routing identifier carried in the first request may be different or the same.

For example, in a case where the association reason carried in the first request indicates that the association update is performed on the UE and the core network device, it means that the UE receives the first routing identifier sent by the core network device. That is, the UE stores the first routing identifier. Then, in a case where the UE requests the association update with the core network device via the first request, the second routing identifier carried in the first request may be the first routing identifier.

For example, the UE stores the second routing identifier, and the core network device associated with the UE is determined by sending the second routing identifier. In a case where the core network device determined based on the second routing identifier and associated with the UE is not the correct core network device, the UE may receive the first routing identifier sent by the core network device. The first routing identifier indicates the correct core network device associated with the UE. In this case, the first routing identifier is different from the second routing identifier.

In an example, in a case where the first response message indicates that the core network device successfully associates with the UE, the first routing identifier is configured for the UE to determine the core network device for the association update with the UE.

In an example, in a case where the first response message indicates that the core network device fails to associate with the UE, the first routing identifier is configured for the UE to redetermine the core network device associated with the UE.

In some embodiments, the UE may receive the first response message and then receive the first routing identifier; or the UE may receive the first routing identifier, and then receive the first response message. The embodiments of the present disclosure do not limit the receiving sequence of the first response message and the first routing identifier.

In some embodiments, the UE may simultaneously receive the first response message and the first routing identifier to reduce signaling consumption. In one implementation, the first response message and the first routing identifier are carried in the DL NAS TRANSPORT message.

In the embodiment of the present disclosure, the UE can determine the core network device corresponding to the UE by receiving the first routing identifier. Then, in a case where the core network device successfully associates with the UE, the UE can determine the core network device receiving the first request based on the first routing identifier in a case where the association update needs to be performed later. In a case where the core network device fails to associate with the UE, the UE can determine a core network device reassociated with the UE based on the first routing identifier.

Based on the same concept, an embodiment of the present disclosure further provides a communication method performed by the core network device.

FIG. 6 is a flowchart of a communication method according to an example. As shown in FIG. 6, the communication method is performed by the core network device. The communication method includes the following step S51.

In step S51, the core network device receives the first request sent by the UE.

In some embodiments, the first request is configured to request the core network device to associate with the UE.

In some embodiments, the UE associated with the core network device is configured to perform the sensing service.

In some embodiments, reference may be made to the implementation in step S11 for other implementations of step S51, which is not described in detail in the embodiment of the present disclosure.

In the embodiment of the present disclosure, the core network device receives the first request and establishes an association with the UE. After the core network device successfully associates with the UE, because the UE has sensing capability, the core network device can quickly search for a sensing-capable UE when the sensing service is needed later. In this way, search time can be reduced and sensing efficiency can be improved.

In the communication method according to the embodiment of the present disclosure, the first request carries at least one of the following: A, B, C, or D.
A. the association reason.
B. the sensing capability of the UE.
C. the location information of the UE.
D. the second routing identifier.

In some embodiments, a specific implementation of the first request in the embodiment of the present disclosure is consistent with a specific implementation of the first request on the UE side. Reference may be made to the specific implementation of the first request involved on the UE side. This is not repeated in the embodiment of the present disclosure.

In the communication method according to the embodiment of the present disclosure, in a case where the interface between the UE and the core network device is in the idle state, the UE needs to trigger the interface between the UE and the core network device to switch to the connected state.

In some embodiments, the second request sent by the UE is received to trigger the interface between the UE and the core network device to switch to the connected state.

In some embodiments, the second request sent by the UE is received to trigger the interface between the UE and the core network device to switch to the connected state. Then, the first request is received to request the core network device to associate with the UE.

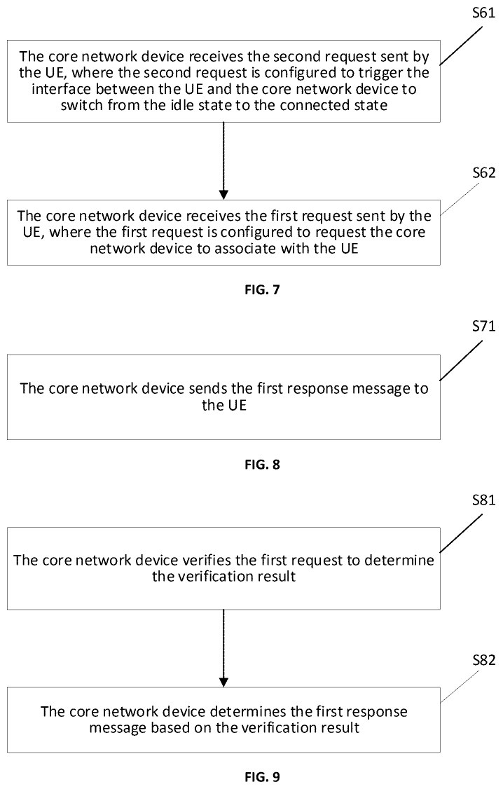

FIG. 7 is a flowchart of a communication method according to an example. As shown in FIG. 7, the method includes the following steps: S61 and S62.

In step S61, the core network device receives the second request sent by the UE, where the second request is configured to trigger the interface between the UE and the core network device to switch from the idle state to the connected state.

In step S62, the core network device receives the first request sent by the UE, where the first request is configured to request the core network device to associate with the UE.

In the embodiment of the present disclosure, in a case where the interface between the UE and the core network device is in the idle state, the second request sent by the UE is received, such that the interface between the UE and the core network device is switched from the idle state to the connected state. In this way, the core network device can later receive data sent by the UE.

In the communication method according to the embodiment of the present disclosure, the core network device needs to provide feedback to the UE on whether the core network device successfully associates with the UE. As shown in FIG. 8, FIG. 8 is a flowchart of a communication method according to an example. The method includes the following step S71.

In step S71, the core network device sends the first response message to the UE.

In some embodiments, the first response message is configured to indicate that the core network device successfully associates with the UE.

In some embodiments, the first response message is configured to indicate that the core network device fails to associate with the UE.

In some embodiments, the first response message is carried in the DL NAS TRANSPORT message.

It should be noted that step S61 may be implemented independently or together with any embodiment of the present disclosure, which is not repeated here. For example, after receiving the first request, the core network device sends the first response message. For example, the core network device receives the second request, triggers the interface between the UE and the core network device to switch from the idle state to the connected state based on the second request, receives the first request, and sends the first response message.

In the communication method according to the embodiment of the present disclosure, the first response message is determined by verifying the first request by the core network device. As shown in FIG. 9, FIG. 9 is a flowchart of a communication method according to an example. The method includes the following steps: S81 and S82.

In step S81, the core network device verifies the first request to determine the verification result.

In some embodiments, the verification result indicates whether verification of the first request by the core network device is passed.

In step S82, the core network device determines the first response message based on the verification result.

In one implementation, in a case where the verification result indicates that verification of the first request by the core network device is passed, the first response message indicates that the core network device successfully associates with the UE.

In another implementation, in a case where the verification result indicates that verification of the first request by the core network device is not passed, the first response message indicates that the core network device fails to associate with the UE.

In an example of the embodiments of the present disclosure, the core network device determines the verification result based on at least one of subscription information or a preset rule.

In some embodiments, the sensing capability of the UE is stored in the subscription information. The subscription information is configured to verify whether the sensing capability of the UE is correct. In one implementation, the sensing capability of the UE stored in the subscription information is identical to the sensing capability of the UE included in the first request, indicating that the sensing capability of the UE is correct. The sensing capability of the UE stored in the subscription information is different from the sensing capability of the UE included in the first request, indicating that the sensing capability of the UE is incorrect.

In some embodiments, the preset rule is configured to determine whether the core network device accepts association with the UE. In one implementation, the core network device determines the second response message based on the preset rule, and the second response message indicates whether the core network device accepts association with the UE.

In an example, the preset rule includes whether the core network device receiving the first request is a serving core network device for the UE. For example, in a case where the core network device is not the serving core network device corresponding to the UE, the core network device cannot accept association with the UE. The preset rule is configured to determine that the core network device cannot accept association with the UE. That is, the second response message is configured to indicate that the core network device cannot accept association with the UE.

In an example, the preset rule includes whether a current load of the core network device can accept the association of the core network device with the UE. For example, in a case where the current load of the core network device is too high to accept association of the core network device with the UE, the preset rule is configured to determine that the core network device cannot accept association with the UE. That is, the second response message is configured to indicate that the core network device cannot accept association with the UE.

In an example of the embodiments of the present disclosure, in a case where the subscription information verifies that the sensing capability of the UE is correct and the preset rule is configured to determine that the core network device accepts association with the UE, the verification result indicates that verification of the first request by the core network device is passed.

In an example of the embodiments of the present disclosure, in a case where the subscription information verifies that the sensing capability of the UE is incorrect and the preset rule is configured to determine that the core network device does not accept association with the UE, the verification result indicates that verification of the first request by the core network device is not passed.

In an example of the embodiments of the present disclosure, in a case where the subscription information verifies that the sensing capability of the UE is incorrect, regardless of whether the core network device determines, based on the preset rule, that the core network device accepts association with the UE, the verification result indicates that verification of the first request by the core network device is not passed.

In an example of the embodiments of the present disclosure, in a case where the preset rule is configured to determine that the core network device does not accept association with the UE, regardless of whether the subscription information verifies that the sensing capability of the UE is correct, the verification result indicates that verification of the first request by the core network device is not passed.

In the embodiment of the present disclosure, the core network device verifies the first request and sends the first response message to the UE based on the verification result. In this way, the UE determines, based on the first response message, whether the core network device successfully associates with the UE, thereby preventing the UE from repeatedly sending the first request and reducing signaling consumption.

In the communication method according to the embodiment of the present disclosure, the core network device sends a first routing identifier to the UE, and the UE may determine the core network device associated with the UE based on the first routing identifier.

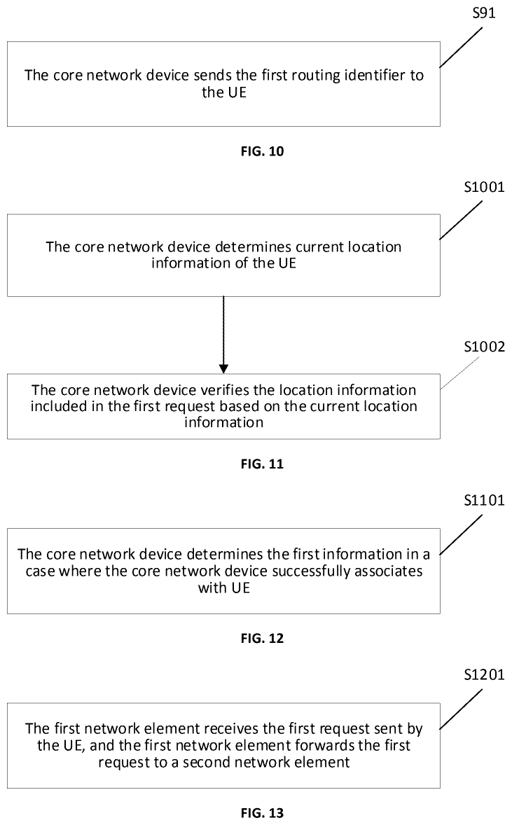

FIG. 10 is a flowchart of a communication method according to an example. As shown in FIG. 10, the communication method is performed by a core network device. The method includes the following step S91.

In step S91, the core network device sends the first routing identifier to the UE.

In some embodiments, a first response message indicates that the core network device successfully associates with the UE, and the first routing identifier is configured for the UE to determine the core network device for the association update with the UE.

In some embodiments, the first response message indicates that the core network device fails to associate with the UE, and the first routing identifier is configured for the UE to redetermine the core network device associated with the UE.

In some embodiments, reference may be made to other implementations of step S41 for other implementations of step S91, which are not described in detail in the embodiment of the present disclosure.

In the embodiment of the present disclosure, the core network device sends the first routing identifier to the UE, such that the UE can determine the core network device corresponding to the UE. Then, in a case where the core network device successfully associates with the UE, the UE can determine the core network device receiving the first request based on the first routing identifier if the association update needs to be performed later. In a case where the core network device fails to associate with the UE, the UE can determine a core network device reassociated with the UE based on the first routing identifier.

In the communication method according to the embodiment of the present disclosure, the core network device verifies the location information reported by the UE by triggering a positioning procedure. As shown in FIG. 11, FIG. 11 is a flowchart of a communication method according to an example. The method includes the following steps: S1001 and S1002.

In step S1001, the core network device determines current location information of the UE.

In step S1002, the core network device verifies the location information included in the first request based on the current location information.

In some embodiments, after the core network device successfully associates with the UE, the core network device performs steps S1001 and S1002.

In some embodiments, the core network device obtains the current location information of the UE by triggering the positioning procedure. Reference may be made to a positioning procedure in the related art for the positioning procedure, which is not described in detail in the embodiments of the present disclosure.

In some embodiments, the core network device determines whether the location information included in the first request is identical based on the current location information.

In one implementation, in a case where the current location information is different from the location information included in the first request, it indicates that a location of the UE changes, and the core network device needs to obtain more accurate location information. In another implementation, in a case where the current location information is identical to the location information included in the first request, it indicates that the location information included in the first request is accurate, and the UE associated with the core network device is accurate.

In the embodiment of the present disclosure, the core network device verifies the location information of the UE to determine whether the location information reported by the UE is accurate. In this way, the accuracy of information of the UE registered in the core network device is ensured, such that the core network device can timely and accurately determine the UE for performing the sensing service.

In the communication method according to the embodiment of the present disclosure, after the core network device successfully associates with the UE, the core network device stores the first information. As shown in FIG. 12, FIG. 12 is a flowchart of a communication method according to an example. The method includes the following step S1101.

In step S1101, the core network device determines the first information in a case where the core network device successfully associates with the UE.

In some embodiments, the first information includes at least one of: a tracking area identifier of the UE, a subscriber permanent identifier of the UE, the location information of the UE, or the sensing capability of the UE.

In an example, the first information includes the tracking area identifier of the UE. The tracking area identifier of the UE is allocated to the UE by the core network device when the UE accesses the core network device. In one implementation, the core network device determines, based on the tracking area identifier, that the UE, which is successfully associated with the core network device, exists in a corresponding tracking area.

In an example, the first information includes the subscriber permanent identifier of the UE. In one implementation, the core network device determines the UE, which successfully associates with the core network device, based on the subscriber permanent identifier.

In an example, the first information includes the location information of the UE. In one implementation, the core network device determines the location of the UE successfully associated with the core network device based on the location information.

In an example, the first information includes the sensing capability of the UE. In one implementation, based on the sensing capability of the UE, the core network device determines a sensing mode of the UE when performing the sensing service and determines whether the UE is the receiver or the transmitter.

In an example, the first information includes the tracking area identifier of the UE and the subscriber permanent identifier of the UE. In one implementation, the core network device determines, based on the tracking area identifier, that the UE, which is successfully associated with the core network device, exists in a corresponding tracking area, and determines, based on the subscriber permanent identifier of the UE, which UE(s) are successfully associated with the core network device.

In an example, the first information includes one or more of the tracking area identifier of the UE, the subscriber permanent identifier of the UE, the location information of the UE, and the sensing capability of the UE. The embodiments of the present disclosure are only illustrative, and the embodiments of the present disclosure do not specifically limit the first information thereto.

It should be noted that step S1101 may be implemented independently or together with any embodiment of the present disclosure, which is not repeated here.

Based on the same concept, an embodiment of the present disclosure further provides a communication method performed by a first network element.

FIG. 13 is a flowchart of a communication method according to an example. As shown in FIG. 13, the method is performed by the first network element. The method includes the following step S1201.

In step S1201, the first network element receives the first request sent by the UE, and the first network element forwards the first request to a second network element.

In some embodiments, the UE sending the first request has the sensing capability.

In some embodiments, the first request is configured to request the core network device to associate with the UE. In one implementation, the core network device is the second network element.

In some embodiments, the UE associated with the core network device is configured to perform the sensing service.

In some embodiments, the first network element selects a network element forwarding the first request based on some standards, such as a capability of the second network element, a location of the second network element, a load of the second network element, and required quality of service (QoS).

In some embodiments, the first network element is the AMF network element.

In some embodiments, the second network element is a newly added network element. One network element with a sensing function is added to the core network device, such that the network element with the sensing function can be associated with the sensing-capable UE. For example, the newly added network element may be referred to as a sensing function (SF) network element.

In some embodiments, the second network element is a redefined network element. The second network element associates with the sensing-capable UE by reusing the existing network element in the core network device. For example, the redefined network element may be a location management function (LMF) network element.

In some embodiments, reference may be made to the implementation in step S11 for other implementations of step S1201, which is not described in detail in the embodiment of the present disclosure.

In the embodiment of the present disclosure, the first network element forwards the first request to the second network element, such that an association is established between the second network element and the UE. In this way, the time for searching for the UE performing the sensing service can be reduced, and sensing efficiency can be improved.

In the communication method according to the embodiment of the present disclosure, the first request carries at least one of the following: A, B, C, or D.
A. the association reason.
B. the sensing capability of the UE.
C. the location information of the UE.
D. the second routing identifier.

It should be understood that a specific implementation of the first request in the embodiment of the present disclosure is consistent with a specific implementation of the first request involved in the UE side and the core network device side. Reference may be made to the specific implementation of the first request involved in the UE side and the core network device side. This is not repeated in the embodiment of the present disclosure.

In the communication method according to the embodiment of the present disclosure, in a case where an interface between the UE and the first network element is in an idle state, the UE needs to trigger the interface between the UE and the first network element to switch from the idle state to a connected state.

In some embodiments, the first network element receives the second request sent by the UE, to trigger the interface between the UE and the first network element to switch from the idle state to the connected state.

In some embodiments, the first network element receives the second request sent by the UE, to trigger the interface between the UE and the first network element to switch from the idle state to the connected state. Then, the first network element receives the first request and forwards the first request to the second network element.

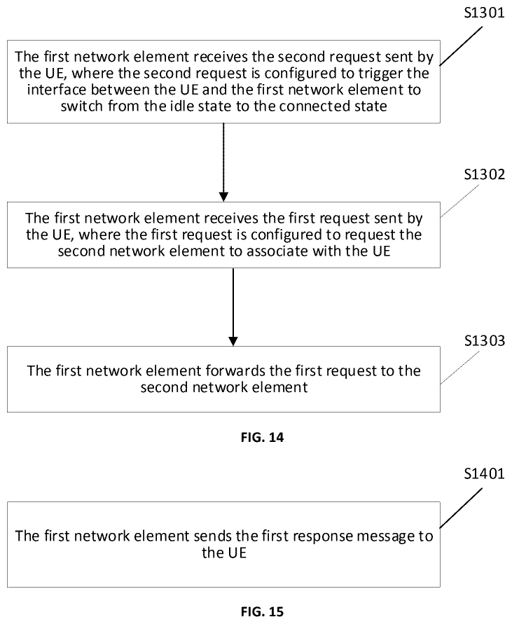

FIG. 14 is a flowchart of a communication method according to an example. As shown in FIG. 14, the method includes the following steps: S1301-S1303.

In step S1301, the first network element receives the second request sent by the UE, where the second request is configured to trigger (or request) the interface between the UE and the first network element to switch from the idle state to the connected state.

In step S1302, the first network element receives the first request sent by the UE, where the first request is configured to request the second network element to associate with the UE.

In step S1303, the first network element forwards the first request to the second network element.

In the embodiment of the present disclosure, in a case where the interface between the UE and the first network element is in the idle state, the first network element receives the second request sent by the UE, such that the interface between the UE and the first network element is switched from the idle state to the connected state. In this way, the first network element can later receive data sent by the UE.

In the communication method according to the embodiment of the present disclosure, the first network element needs to provide feedback to the UE on whether the second network element successfully associates with the UE. As shown in FIG. 15, FIG. 15 is a flowchart of a communication method according to an example. The method includes the following step S1401.

In step S1401, the first network element sends the first response message to the UE.

In some embodiments, the first response message is carried in the DL NAS TRANSPORT message.

In some embodiments, the first response message is configured to indicate that the core network device successfully associates with the UE.

In some embodiments, the first response message is configured to indicate that the core network device fails to associate with the UE.

In some embodiments, reference may be made to an optional implementation of step S71 for optional implementations of step S1401, which is not described in the embodiment of the present disclosure.

It should be noted that step S1401 may be implemented independently or together with any embodiment of the present disclosure, which is not repeated here. For example, after receiving the first request, the first network element sends the first response message. For example, the first network element receives the second request, triggers the interface between the UE and the first network element to switch from the idle state to the connected state based on the second request, receives the first request, and sends the first response message.

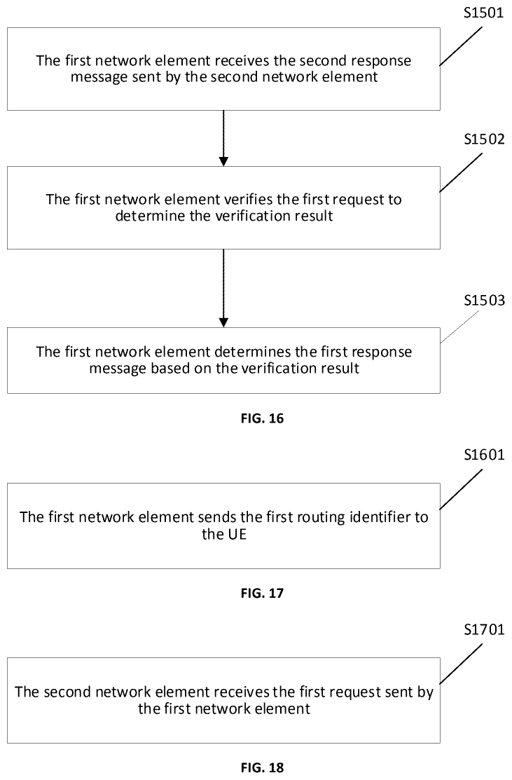

In the communication method according to the embodiment of the present disclosure, the first response message is determined by verifying the first request by the first network element. As shown in FIG. 16, FIG. 16 is a flowchart of a communication method according to an example. The method includes the following steps: S1501-S1503.

In step S1501, the first network element receives the second response message sent by the second network element.

In some embodiments, the second response message is determined by the second network element based on a preset rule.

In some embodiments, the second response message is configured to indicate whether the second network element accepts association with the UE.

In an example, the preset rule includes whether the second network element receiving the first request is a serving second network element of the UE. For example, in a case where the second network element is not the serving second network element corresponding to the UE, the second network element cannot accept association with the UE. The preset rule is configured to determine that the second network element cannot accept association with the UE. That is, the second response message is configured to indicate that the second network element cannot accept association with the UE.

In an example, the preset rule includes whether a current load of the second network element can accept the association of the second network element with the UE. For example, in a case where the current load of the second network element is too high to accept the association of the second network element with the UE, the preset rule is configured to determine that the second network element cannot accept association with the UE. That is, the second response message is configured to indicate that the second network element cannot accept the association with the UE.

In step S1502, the first network element verifies the first request to determine the verification result.

In some embodiments, the verification result indicates whether verification of the first request by the first network element is passed.

In step S1503, the first network element determines the first response message based on the verification result.

In one implementation, in a case where the verification result indicates that verification of the first request by the first network element is passed, the first response message indicates that the core network device successfully associates with the UE.

In another implementation, in a case where the verification result indicates that verification of the first request by the first network element is not passed, the first response message indicates that the core network device fails to associate with the UE.

In an example of the embodiments of the present disclosure, the first network element determines the verification result based on at least one of the subscription information or the second response message.

In some embodiments, the sensing capability of the UE is stored in the subscription information. The subscription information is configured to verify whether the sensing capability of the UE is correct. In one implementation, the sensing capability of the UE stored in the subscription information is identical to the sensing capability of the UE included in the first request, indicating that the sensing capability of the UE is correct. The sensing capability of the UE stored in the subscription information is different from the sensing capability of the UE included in the first request, indicating that the sensing capability of the UE is incorrect.

In an example of the embodiments of the present disclosure, in a case where the subscription information verifies that the sensing capability of the UE is correct and the second response message indicates that the second network element accepts association with the UE, the verification result indicates that the verification of the first request by the first network element is passed.

In an example of the embodiments of the present disclosure, in a case where the subscription information verifies that the sensing capability of the UE is incorrect and the second response message indicates that the second network element does not accept association with the UE, the verification result indicates that the verification of the first request by the first network element is not passed.

In an example of the embodiments of the present disclosure, in a case where the subscription information verifies that the sensing capability of the UE is incorrect, regardless of whether the second response message indicates that the second network element accepts association with the UE, the verification result indicates that verification of the first request by the first network element is not passed.

In an example of the embodiments of the present disclosure, in a case where the second response message indicates that the second network element does not accept association with the UE, regardless of whether the subscription information verifies that the sensing capability of the UE is correct, the verification result indicates that verification of the first request by the first network element is not passed.

It is worth noting that, for the first network element and the second network element, the second response message indicates whether the second network element accepts association with the UE. However, for the UE, the UE may not know which network element in the core network device associates with the UE, and the UE determines whether the core network device accepts association with the UE. That is, the first network element and the second network element determine whether the second network element accepts association with the UE via the second response message. The UE determines whether the core network device accepts association with the UE via the first response message.

In the embodiment of the present disclosure, the first network element verifies the first request and sends the first response message to the UE based on the verification result. In this way, the UE determines whether the core network device successfully associates with the UE based on the first response message, thereby preventing the UE from repeatedly sending the first request and reducing signaling consumption.

In the communication method according to the embodiment of the present disclosure, the core network device sends the first routing identifier to the UE, and the UE may determine the core network device associated with the UE based on the first routing identifier.

FIG. 17 is a flowchart of a communication method according to an example. As shown in FIG. 17, the method includes the following step S1601.

In step S1601, the first network element sends the first routing identifier to the UE.

In some embodiments, the first response message indicates that the core network device successfully associates with the UE, and the first routing identifier is configured for the UE to determine the core network device for the association update with the UE.

In some embodiments, the first response message indicates that the core network device fails to associate with the UE, and the first routing identifier is configured for the UE to redetermine a core network device associated with the UE.

In some embodiments, reference may be made to other implementations of step S41 for other implementations of step S1601, which is not described in detail in the embodiment of the present disclosure.

In an embodiment of the present disclosure, the first network element sends the first routing identifier to the UE, enabling the UE to determine the core network device corresponding to the UE. Then, in a case where the core network device successfully associates with the UE, the UE can determine the core network device associated with the UE based on the first routing identifier when the association update is needed later. In a case where the core network device fails to associate with the UE, the UE can determine the core network device that reassociates with the UE based on the first routing identifier.

In the communication method according to the embodiment of the present disclosure, the first network element sends at least one of the tracking area identifier of the UE or the subscriber permanent identifier of the UE to the second network element. The tracking area identifier of the UE is allocated to the UE by the first network element.

In some embodiments, the first network element sends the tracking area identifier of the UE and the subscriber permanent identifier of the UE while sending the first request. In some other embodiments, the first network element sends the first request, the tracking area identifier of the UE, and the subscriber permanent identifier of the UE separately.

Based on the same concept, an embodiment of the present disclosure further provides a communication method performed by the second network element.

FIG. 18 is a flowchart of a communication method according to an example. As shown in FIG. 18, the method is performed by the second network element. The method includes the following step S1701.

In step S1701, the second network element receives the first request sent by the first network element.

In some embodiments, the UE sending the first request has the sensing capability.

In some embodiments, the first request is configured to request the core network device to associate with the UE. In one implementation, the core network device is the second network element.

In some embodiments, the UE associated with the core network device is configured to perform the sensing service.

In some embodiments, reference may be made to an optional implementation of step S1201 for optional implementations of step S1701, which is not described in the embodiment of the present disclosure.

In the embodiment of the present disclosure, the first network element forwards the first request to the second network element, thereby establishing an association between the core network device and the UE. In this way, the time for searching for the UE performing the sensing service can be reduced, and sensing efficiency can be improved.

In the communication method according to the embodiment of the present disclosure, the first request carries at least one of the following: A, B, C, or D.
A. the association reason.
B. the sensing capability of the UE.
C. the location information of the UE.
D. the second routing identifier.

It should be understood that a specific implementation of the first request in the embodiment of the present disclosure is consistent with a specific implementation of the first request on the UE side. Reference may be made to the specific implementation of the first request involved on the UE side. This is not repeated in the embodiment of the present disclosure.

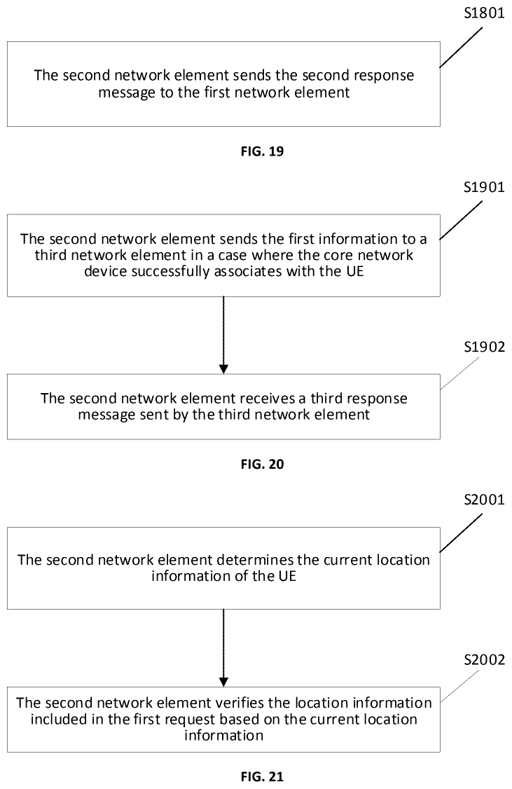

FIG. 19 is a flowchart of a communication method according to an example. As shown in FIG. 19, the communication method includes the following step S1801.

In step S1801, the second network element sends the second response message to the first network element.

In some embodiments, the second response message is configured to indicate whether the second network element accepts association with the UE.

For example, in a case where the second network element is not a serving second network element corresponding to the UE, the second network element cannot accept association with the UE. The second response message is configured to indicate that the second network element cannot accept association with the UE.

For example, in a case where a current load of the second network element is too high to accept the association of the second network element with the UE, the second response message is configured to indicate that the second network element cannot accept the association with the UE.

FIG. 20 is a flowchart of a communication method according to an example. As shown in FIG. 20, the method includes the following steps: S1901 and S1902.

In step S1901, the second network element sends the first information to a third network element in a case where the core network device successfully associates with the UE.

In some embodiments, the first information includes at least one of the tracking area identifier of the UE, the subscriber permanent identifier of the UE, the sensing capability of the UE, or the location information of the UE.

The tracking area identifier of the UE and the subscriber permanent identifier of the UE are sent by the first network element to the second network element.

In step S1902, the second network element receives a third response message sent by the third network element.

In some embodiments, the third response message is configured to indicate that the third network element stores the first information.

In some embodiments, after the third network element stores the first information, the third network element may determine the UE associated with the second network element based on the first information.

In the communication method according to the embodiment of the present disclosure, the second network element verifies the location information reported by the UE by triggering the positioning procedure. As shown in FIG. 21, FIG. 21 is a flowchart of a communication method according to an example. The method includes the following steps: S2001 and S2002.

In step S2001, the second network element determines the current location information of the UE.

In some embodiments, the second network element triggers the positioning procedure via the LMF network element.

In step S2002, the second network element verifies the location information included in the first request based on the current location information.

In some embodiments, after the core network device successfully associates with the UE, the second network element performs steps S1001 and S1002.

In some embodiments, the core network device obtains the current location information of the UE by triggering the positioning procedure. Reference may be made to the positioning procedure in the related art for the positioning procedure, which is not described in detail in the embodiments of the present disclosure.

In the communication method according to the embodiment of the present disclosure, the first network element is the AMF network element; the second network element is a newly added network element or a redefined network element; and the third network element is the network repository function (NRF) network element.

Based on an identical concept, an embodiment of the present disclosure further provides a communication method. The method is performed through interactions among all the network elements in the core network device.

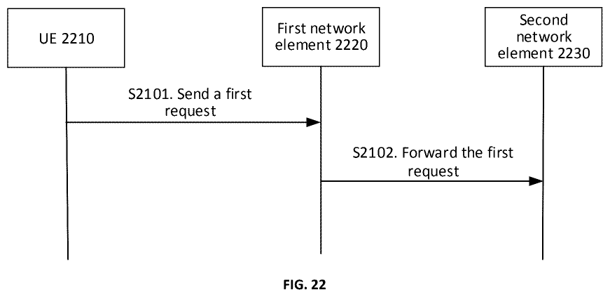

FIG. 22 is a flowchart of a communication method according to an example. As shown in FIG. 22, the method includes the following steps: S2101 and S2102.

In step S2101, the first network element 2220 receives the first request sent by the UE 2210.

In step S2102, the first network element 2220 forwards the first request to the second network element 2230.

In some embodiments, the first request is configured to request the core network device to associate with the UE. The UE has the sensing capability. The UE associated with the core network device is configured to perform the sensing service.

In the embodiment of the present disclosure, the first network element forwards the first request to the second network element, thereby establishing an association between the core network device and the UE. After the core network device successfully associates with the UE, because the UE has the sensing capability, the core network device can quickly search for the sensing-capable UE when the sensing service is needed later. In this way, search time can be reduced and sensing efficiency can be improved.

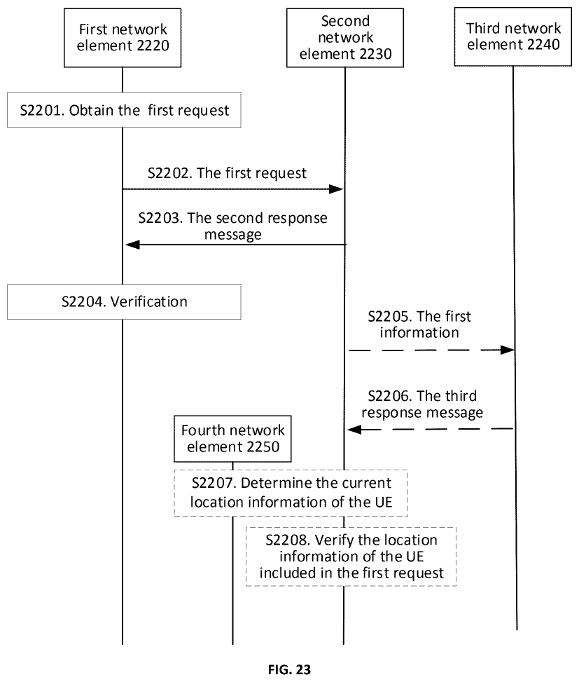

In order to more clearly describe that all network elements in the core network device interact with each other to perform the communication method according to the embodiment of the present disclosure, the communication method according to the embodiment of the present disclosure is completely illustrated with the flowchart shown in FIG. 23 as an instance.

In step S2201, the first network element 2220 obtains the first request.

In some embodiments, the first network element 2220 receives the first request sent by the UE 2210.

In some embodiments, the first request is configured to request the core network device to associate with the UE. The UE has the sensing capability. The UE associated with the core network device is configured to perform the sensing service.

In some embodiments, the first request carries at least one of the following: the association reason, the sensing capability of the UE, the location information of the UE, or the second routing identifier.

In step S2202, the first network element 2220 forwards the first request to the second network element 2230.

In some embodiments, the first network element selects the second network element forwarding the first request based on some standards, such as the capability of the second network element, the location of the second network element, the load of the second network element, and the required QoS.

In step S2203, the second network element 2230 sends the second response message to the first network element 2220.

In some embodiments, the second response message is determined by the second network element based on the preset rule.

In some embodiments, the second response message is configured to indicate whether the second network element accepts association with the UE.

In an example, the preset rule includes whether the second network element is a serving second network element of the UE. For example, in a case where the second network element is not the serving second network element of the UE, the second network element cannot accept association with the UE. The second response message is configured to indicate that the second network element cannot accept association with the UE.

In an example, the preset rule includes whether a current load of the second network element can accept the association of the second network element with the UE. For example, the current load of the second network element is too high to accept association of the second network element with the UE; that is, the second response message is configured to indicate that the second network element cannot accept association with the UE.

In step S2204, the first network element 2220 verifies the first request based on at least one of the subscription information or the second response message.

In some embodiments, the sensing capability of the UE is stored in the subscription information. The subscription information is configured to verify whether the sensing capability of the UE is correct. In one implementation, the sensing capability of the UE stored in the subscription information is identical to the sensing capability of the UE included in the first request, indicating that the sensing capability of the UE is correct. The sensing capability of the UE stored in the subscription information is different from the sensing capability of the UE included in the first request, indicating that the sensing capability of the UE is incorrect.

In an example, in a case where the subscription information verifies that the sensing capability of the UE is correct and the second response message indicates that the second network element accepts association with the UE, verification of the first request by the first network element is passed, and the core network device successfully associates with the UE.

In an example, in a case where the subscription information verifies that the sensing capability of the UE is incorrect and the second response message indicates that the second network element does not accept association with the UE, verification of the first request by the first network element is not passed, and the core network device fails to associate with the UE.

In an example, in a case where the subscription information verifies that the sensing capability of the UE is incorrect, regardless of whether the second response message indicates that the second network element accepts association with the UE, verification of the first request by the first network element is not passed, and the core network device fails to associate with the UE.

In an example, in a case where the second response message indicates that the second network element does not accept association with the UE, regardless of whether the subscription information verifies that the sensing capability of the UE is correct, verification of the first request by the first network element is not passed, and the core network device fails to associate with the UE.

In step S2205, the second network element 2230 sends the first information to the third network element 2240.

In some embodiments, the second network element sends the first information to the third network element in a case where the core network device successfully associates with the UE.

In some embodiments, the first information includes at least one of the tracking area identifier of the UE, the subscriber permanent identifier of the UE, the sensing capability of the UE, or the location information of the UE.

In some embodiments, the tracking area identifier of the UE and the subscriber permanent identifier of the UE are sent by the first network element to the second network element.

In step S2206, the third network element 2240 sends the third response message to the second network element 2230.

In some embodiments, the third response message is configured to indicate that the third network element stores the first information.

In step S2207, the second network element 2230 determines the location information (or current location information) of the UE.

In some embodiments, the second network element determines the location information of the UE in a case where the core network device successfully associates with the UE.

In some embodiments, the second network element verifies the location information of the UE carried in the first request by triggering the positioning procedure.

In some embodiments, the second network element 2230 triggers the positioning procedure via a fourth network element 2250. In one implementation, the fourth network element 2250 is the AMF network element.

In step S2208, the second network element 2230 verifies the location information of the UE included in the first request.

In some embodiments, in a case where the current location information is different from the location information included in the first request, it indicates that the location of the UE changes, and the core network device needs to obtain more accurate location information. In another implementation, in a case where the current location information is identical to the location information included in the first request, it indicates that the location information included in the first request is accurate, and the UE associated with the core network device is accurate.

In the embodiment of the present disclosure, the first network element forwards the first request to the second network element, thereby establishing an association between the core network device and the UE. After the core network device successfully associates with the UE, because the UE has sensing capability, the core network device can quickly search for a sensing-capable UE when the sensing service is needed later. In this way, search time can be reduced and sensing efficiency can be improved.

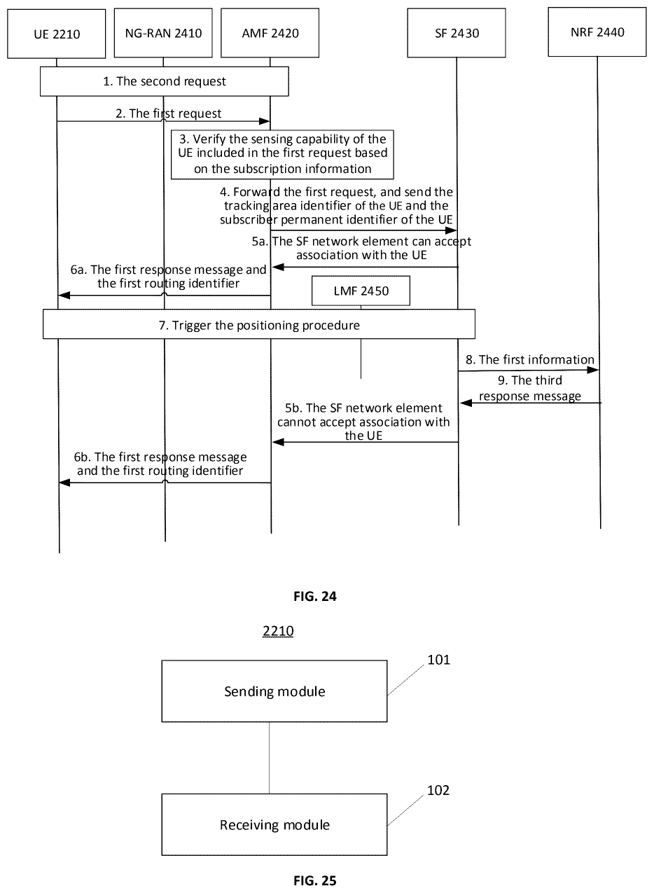

In order to more clearly describe the communication method according to the embodiment of the present disclosure, a detailed and complete illustration is provided below, with the flowchart shown in FIG. 24 as an example. The AMF network element (i.e. AMF) 2420 is the first network element. The SF network element (i.e. SF) 2430 is the second network element. An NRF network element (i.e. NRF) 2440 is the third network element. Next generation radio access network (NG-RAN) 2410 is also shown in FIG. 24.
1. In a case where an interface between the UE and the AMF network element is in the idle state, the UE sends the second request to the AMF network element, to trigger the interface between the UE and the AMF network element to switch from the idle state to the connected state.
2. The UE sends the first request to the AMF network element. The first request carries at least one of: the association reason, the sensing capability of the UE, the location information of the UE, or the second routing identifier.
3. The AMF network element verifies the sensing capability of the UE included in the first request based on the subscription information.
4. The AMF network element forwards the first request to the SF network element and sends the tracking area identifier of the UE and the subscriber permanent identifier of the UE to the SF network element.
5. The SF network element sends the second response message to the AMF network element. The second response message is configured to indicate whether the SF network element accepts association with the UE.
5a. The second response message is configured to indicate that the SF network element accepts association with the UE.
6a. The AMF network element sends the first response message and the first routing identifier to the UE. The first response message is configured to indicate that the SF network element successfully associates with the UE. The first routing identifier is configured for the UE to determine the SF network element for the association update with the UE.
7. The SF network element triggers the positioning procedure via the LMF network element 2450 to determine the current location information of the UE. The location information of the UE included in the first request is verified based on the current location of the UE, such that more accurate location information of the UE can be obtained.
8. In a case where the SF network element successfully associates with the UE, the SF may send the first information to the NRF network element. The first information is configured to indicate that the UE associated with the SF network element exists in the tracking area corresponding to the tracking area identifier, and to indicate the subscriber permanent identifier of the UE, the location information of the UE, and the sensing information.
9. The NRF network element may send the third response message to the SF network element.
5b. The second response message is configured to indicate that the SF network element does not accept association with the UE.
6b. The AMF network element sends the first response message and the first routing identifier to the UE. The first response message is configured to indicate that the SF network element fails to associate with the UE. The first routing identifier is configured for the UE to redetermine the SF network element associated with the UE.

In an embodiment of the present disclosure, the UE associates with the SF network element, enabling the SF network element to find and select the UE effectively. Thus, search time can be reduced and sensing efficiency can be improved.

It is to be noted that those skilled in the art can understand that all the implementations/embodiments related to the embodiments of the present disclosure can be used together with the above embodiments or independently. Whether the implementations/embodiments are used separately or together with the above embodiments, they have a similar implementation principle. In implementation of the present disclosure, some embodiments are described with an implementation of using the implementations/embodiments in combination with the above embodiments. Clearly, those skilled in the art can understand that such illustration does not limit the embodiments of the present disclosure.

Based on an identical concept, an embodiment of the present disclosure further provides a communication apparatus.

It may be understood that the communication apparatus according to the embodiment of the present disclosure includes at least one of a corresponding hardware structure configured to execute respective functions or a corresponding software module configured to perform respective functions, thereby achieving the functions. By combining units and algorithmic steps of each instance disclosed in the embodiment of the present disclosure, the embodiment of the present disclosure may be implemented in the form of hardware or a combination of hardware and computer software. Whether a function is executed in a mode of hardware or hardware driven by computer software depends on a specific application and the design constraints of the technical solution. Those skilled in the art may achieve the described functions for each particular application through different methods, and such implementation is not considered to fall beyond the scope of the technical solution of the embodiments of the present disclosure.

FIG. 25 is a block diagram of the UE 2210 according to an example. With reference to FIG. 25, the UE 2210 includes a sending module 101.

The sending module 101 is configured to send the first request. The first request is configured to request the core network device to associate with the UE. The UE has the sensing capability. The UE associated with the core network device is configured to perform the sensing service.

In one implementation, a receiving module 102 is configured to receive the first response message. The first response message is configured to indicate that the core network device successfully associates with the UE or the core network device fails to associate with the UE.

In one implementation, the first response message is determined based on the verification result of verifying the first request by the core network device. The verification result indicates whether verification of the first request by the core network device is passed.

In one implementation, the verification result is determined based on at least one of the subscription information or the preset rule. The subscription information is configured to verify whether the sensing capability of the UE is correct. The preset rule is configured to determine whether the core network device accepts association with the UE.

In one implementation, the verification result is determined based on the subscription information and the preset rule as follows: in a case where the subscription information verifies that the sensing capability of the UE is correct and the preset rule is configured to determine that the core network device accepts association with the UE, the verification result indicates that verification of the first request by the core network device is passed.

In one implementation, the verification result is determined based on at least one of the subscription information or the preset rule as follows: in a case where the subscription information verifies that the sensing capability of the UE is incorrect and/or the preset rule is configured to determine that the core network device does not accept association with the UE, the verification result indicates that verification of the first request by the core network device is not passed.

In one implementation, in a case where the verification result indicates that verification of the first request by the core network device is passed, the first response message is configured to indicate that the core network device successfully associates with the UE; or in a case where the verification result indicates that verification of the first request by the core network device is not passed, the first response message is configured to indicate that the core network device fails to associate with the UE.

In one implementation, the receiving module 102 is further configured to receive a first routing identifier. The first routing identifier is configured for the UE to determine the core network device for the association update with the UE in a case where the first response message indicates that the core network device successfully associates with the UE. The first routing identifier is configured for the UE to redetermine the core network device associated with the UE in a case where the first response message indicates that the core network device fails to associate with the UE.

In one implementation, the sending module 101 is configured to send the second request in a case where the interface between the UE and the core network device is in the idle state. The second request is configured to request the interface between the UE and the core network device to switch from the idle state to the connected state.

In one implementation, the first request carries at least one of the following: the association reason, where the association reason is configured to indicate that the UE and the core network device perform the initial association, or the UE and the core network device perform the association update; the sensing capability of the UE; the location information of the UE; or the second routing identifier. The second routing identifier is configured to indicate the core network device associated with the UE.

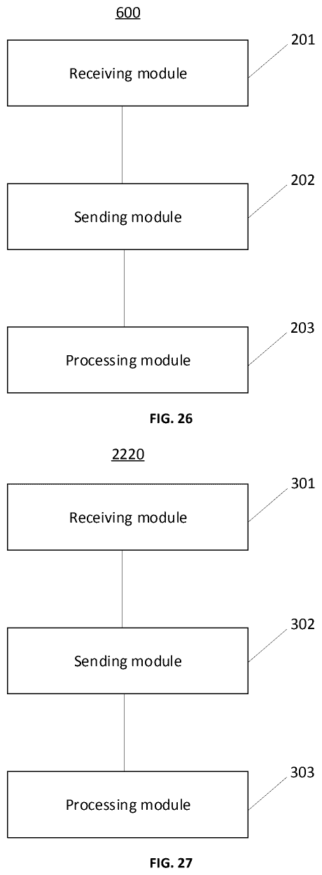

FIG. 26 is a block diagram of a core network device 600 according to an example. With reference to FIG. 26, the core network device 600 includes a receiving module 201.

The receiving module 201 is configured to receive the first request. The first request is configured to request the core network device to associate with the UE. The UE has the sensing capability. The UE associated with the core network device is configured to perform the sensing service.

In one implementation, a sending module 202 is configured to send the first response message. The first response message is configured to indicate that the core network device successfully associates with the UE or the core network device fails to associate with the UE.

In one implementation, a processing module 203 is configured to verify the first request to determine the verification result, where the verification result indicates whether the verification of the first request by the core network device is passed; and determine the first response message based on the verification result.

In one implementation, the processing module 203 is configured to determine the verification result based on at least one of the subscription information or the preset rule. The subscription information is configured to verify whether the sensing capability of the UE is correct. The preset rule is configured to determine whether the core network device accepts association with the UE.

In one implementation, the processing module 203 is configured to determine that the verification result indicates that verification of the first request by the core network device is passed in a case where the subscription information verifies that the sensing capability of the UE is correct, and the preset rule is configured to determine that the core network device accepts association with the UE.

In one implementation, the processing module 203 is configured to determine that the verification result indicates that the verification of the first request by the core network device is not passed in a case where the subscription information verifies that the sensing capability of the UE is incorrect and/or the preset rule is configured to determine that the core network device does not accept association with the UE.

In one implementation, the processing module 203 is configured to determine that the first response message is configured to indicate that the core network device successfully associates with the UE in a case where the verification result indicates that the verification of the first request by the core network device is passed; or
determine that the first response message is configured to indicate that the core network device fails to associate with the UE in a case where the verification result indicates that the verification of the first request by the core network device is not passed.

In one implementation, the sending module 202 is configured to send the first routing identifier. The first routing identifier is configured for the UE to determine the core network device for the association update with the UE in a case where the first response message indicates that the core network device successfully associates with the UE. The first routing identifier is configured for the UE to redetermine the core network device associated with the UE in a case where the first response message indicates that the core network device fails to associate with the UE.

In one implementation, the receiving module 201 is configured to receive the second request. The second request is configured to request the interface between the UE and the core network device to switch from the idle state to the connected state.

In one implementation, the first request includes at least one of the following: the association reason, where the association reason is configured to indicate that the UE and the core network device perform the initial association, or the UE and the core network device perform the association update; the sensing capability of the UE; the location information of the UE; or the second routing identifier. The second routing identifier is configured to indicate the core network device associated with the UE.

In one implementation, the processing module 203 is configured to determine the current location information of the UE, and verify the location information of the UE included in the first request based on the current location information.

In one implementation, the processing module 203 is configured to determine first information in a case where the core network device successfully associates with the UE. The first information is configured to indicate at least one of: successful association of the core network device with the UE, the tracking area identifier of the UE, the subscriber permanent identifier of the UE, the sensing capability of the UE, or the location information of the UE.

FIG. 27 is a block diagram of a first network element 2220 according to an example. With reference to FIG. 27, the first network element 2220 includes a receiving module 301 and a sending module 302.

The receiving module 301 is configured to receive the first request. The sending module 302 is configured to forward the first request to the second network element. The first request is configured to request the core network device to associate with the UE. The UE has the sensing capability. The UE associated with the core network device is configured to perform the sensing service.

In one implementation, the sending module 302 is configured to send the first response message to the UE. The first response message is configured to indicate that the core network device successfully associates with the UE or the core network device fails to associate with the UE.

In one implementation, a processing module 303 is configured to verify the first request to determine the verification result, where the verification result indicates whether the verification of the first request by the first network element is passed; and determine the first response message based on the verification result.

In one implementation, the processing module 303 is configured to receive the second response message sent by the second network element, where the second response message is determined by the second network element based on the preset rule, and the second response message is configured to indicate whether the second network element accepts association with the UE; and determine the verification result based on at least one of the subscription information or the second response message. The subscription information is configured to verify whether the sensing capability of the UE is correct. The second response message is configured to indicate whether the second network element accepts association with the UE.

In one implementation, determining the verification result based on at least one of the subscription information or the second response message includes: determining that the verification result indicates that the verification of the first request by the first network element is passed, in a case where the subscription information verifies that the sensing capability of the UE is correct and the second response message is configured to indicate that the second network element accepts association with the UE.

In one implementation, determining the verification result based on at least one of the subscription information or the second response message includes: determining that the verification result indicates that the verification of the first request by the first network element is not passed, in a case where the subscription information verifies that the sensing capability of the UE is incorrect and/or the second response message is configured to indicate that the second network element does not accept association with the UE.

In one implementation, determining the first response message based on the verification result includes: determining that the first response message is configured to indicate that the core network device successfully associates with the UE, in a case where the verification result indicates that the verification of the first request by the first network element is passed; or determining that the first response message is configured to indicate that the core network device fails to associate with the UE, in a case where the verification result indicates that the verification of the first request by the first network element is not passed.

In one implementation, the sending module 302 is configured to send the first routing identifier to the UE. The first routing identifier is configured for the UE to determine the core network device for the association update with the UE in a case where the first response message indicates that the core network device successfully associates with the UE. The first routing identifier is configured for the UE to redetermine the core network device associated with the UE in a case where the first response message indicates that the core network device fails to associate with the UE.

In one implementation, the receiving module 301 is configured to receive the second request sent by the UE. The second request is configured to request the interface between the UE and the first network element to switch to the connected state.

In one implementation, the first request includes at least one of the following: the association reason, where the association reason is configured to indicate that the UE and the core network device perform the initial association, or the UE and the core network device perform the association update; the sensing capability of the UE; the location information of the UE; or the second routing identifier. The second routing identifier is configured to indicate the core network device associated with the UE.

In one implementation, the sending module 302 is configured to send at least one of the tracking area identifier of the UE or the subscriber permanent identifier of the UE to the second network element.

In one implementation, the first network element is the AMF network element. The second network element is the newly added network element or the redefined network element.

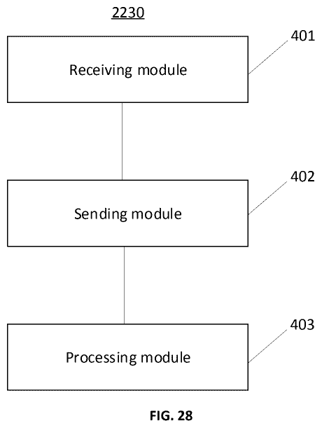

FIG. 28 is a block diagram of a second network element 2230 according to an example. With reference to FIG. 28, the second network element 2230 includes a receiving module 401.

The receiving module 401 is configured to receive the first request sent by the first network element. The first request is configured to request the core network device to associate with the UE. The UE has the sensing capability. The UE associated with the core network device is configured to perform the sensing service.

In one implementation, a sending module 402 is configured to send the second response message to the first network element. The second response message is configured to indicate whether the core network device accepts association with the UE.

In one implementation, the second response message is configured for the first network element to determine the first response message. The first response message is configured to indicate that the core network device successfully associates with the UE or the core network device fails to associate with the UE.

In one implementation, the first response message is determined based on the verification result of verifying the first request by the first network element. The verification result indicates whether verification of the first request by the first network element is passed.

In one implementation, the verification result is determined based on at least one of the subscription information or the second response message. The subscription information is configured to verify whether the sensing capability of the UE is correct. The second response message is configured to indicate whether the second network element accepts association with the UE.

In one implementation, the verification result is determined based on the subscription information and the second response message as follows: in a case where the subscription information verifies that the sensing capability of the UE is correct and the second response message is configured to indicate that the second network element accepts association with the UE, the verification result indicates that the verification of the first request by the first network element is passed.

In one implementation, the verification result is determined based on at least one of the subscription information or the second response message as follows: in a case where the subscription information verifies that the sensing capability of the UE is incorrect and/or the second response message is configured to indicate that the second network element does not accept association with the UE, the verification result indicates that the verification of the first request by the first network element is not passed.

In one implementation, in a case where the verification result indicates that the verification of the first request by the first network element is passed, the first response message is configured to indicate that the core network device successfully associates with the UE; or in a case where the verification result indicates that the verification of the first request by the first network element is not passed, the first response message is configured to indicate that the core network device fails to associate with the UE.

In one implementation, the receiving module 401 is configured to receive at least one of the tracking area identifier of the UE or the subscriber permanent identifier of the UE sent by the first network element. In one implementation, the sending module 402 is configured to send the first information to the third network element in a case where the core network device successfully associates with the UE. The first information includes at least one of the tracking area identifier of the UE, the subscriber permanent identifier of the UE, the sensing capability of the UE, or the location information of the UE.

In one implementation, the receiving module 401 is configured to receive the third response message sent by the third network element. The third response message is configured to indicate that the third network element stores the first information.

In one implementation, the first request includes at least one of the following: the association reason, where the association reason is configured to indicate that the UE and the core network device perform the initial association, or the UE and the core network device perform the association update; the sensing capability of the UE; the location information of the UE; or the second routing identifier. The second routing identifier is configured to indicate the core network device associated with the UE.

In one implementation, a processing module 403 is configured to determine the current location information of the UE, and verify the location information of the UE included in the first request based on the current location information.

In one implementation, the first network element is the AMF network element. The second network element is the newly added network element or the redefined network element. The third network element is the NRF network element.

For the apparatus in the embodiments, a specific method for each module to execute an operation is described in detail in the embodiments relating to the method, which is not described in detail here.

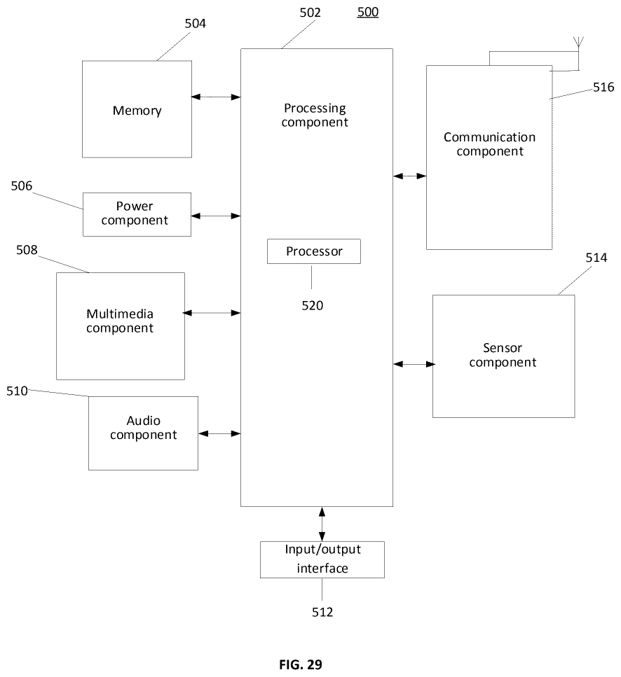

FIG. 29 is a block diagram of a structure of a terminal 500 according to an example. For example, the terminal 500 may be a mobile phone, a computer, a digital broadcast terminal, a messaging device, a game console, a tablet device, a medical device, a fitness device, a personal digital assistant, etc. In an example, the terminal 500 may be the UE 2210.

With reference to FIG. 29, the terminal 500 may include one or more of the following components: a processing component 502, a memory 504, a power component 506, a multimedia component 508, an audio component 510, an input/output (I/O) interface 512, a sensor component 514, and a communication component 516.

The processing component 502 generally controls all operations of the terminal 500, such as operations associated with display, telephone call, data communication, camera operation, and recording operation. The processing component 502 may include one or more processors 520 configured to execute instructions, so as to perform all or some steps of the method. In addition, the processing component 502 may include one or more modules to facilitate interaction between the processing component 502 and other components. For example, the processing component 502 may include a multimedia module to facilitate interaction between the multimedia component 508 and the processing component 502.

As used herein, the term processor may refer to one processor that performs the defined functions or a plurality of processors that collectively perform defined functions, such that the execution of the individual defined functions may be divided amongst such processors.

The memory 504 is configured to store various types of data, so as to support operations on the terminal 500. Instances of the data include instructions for any application or method operating on the terminal 500, contact data, phonebook data, a message, a picture, a video, etc. The memory 504 may be implemented by any volatile or nonvolatile memory device or their combinations, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk, or an optical disk.

The power component 506 supplies power to various components of the terminal 500. The power component 506 may include a power management system, one or more power supplies, and other components for generating, managing, and distributing power to the terminal 500.

The multimedia component 508 includes a screen configured to provide an output interface between the terminal 500 and a user. In some embodiments, the screen may include a liquid crystal display (LCD) and a touch panel (TP). In a case where the screen includes the touch panel, the screen may be implemented as a touch screen to receive an input signal from the user. The touch panel includes one or more touch sensors to sense touch, slide, and gestures on the touch panel. The touch sensor may sense a boundary of a touch or slide operation, and detect duration and pressure related to the touch or slide operation. In some embodiments, the multimedia component 508 includes at least one of a front-facing camera or a rear-facing camera. In a case where the terminal 500 is in an operation mode, such as a photographing mode or a video mode, at least one of the front-facing camera or the rear-facing camera may receive external multimedia data. Each of the front-facing camera and the rear-facing camera may be one fixed optical lens system or may have a focal length and an optical zoom capability.

The audio component 510 is configured to at least one of output or input an audio signal. For example, the audio component 510 includes one microphone (MIC). The microphone is configured to receive an external audio signal in a case where the terminal 500 is in operation modes, such as a call mode, a recording mode, and a voice identification mode. The received audio signal may be further stored in the memory 504 or sent via the communication component 516. In some embodiments, the audio component 510 further includes one speaker configured to output an audio signal.

The I/O interface 512 provides an interface between the processing component 502 and a peripheral interface module. The peripheral interface module may be a keyboard, a click wheel, a button, etc. The buttons may include, but are not limited to, a home button, a volume button, a start button, and a lock button.

The sensor component 514 includes one or more sensors configured to provide various aspects of state assessment for the terminal 500. For example, the sensor component 514 may detect the on/off state of the terminal 500 and the relative positioning of components, such as a display and a keypad of the terminal 500. The sensor component 514 may further detect a change in location of the terminal 500 or a component of the terminal 500, the presence or absence of contact between the user and the terminal 500, an orientation or acceleration/deceleration of the terminal 500, and a change in temperature of the terminal 500. The sensor component 514 may include a proximity sensor configured to detect the presence of a nearby object without any physical contact. The sensor component 514 may further include an optical sensor, such as a complementary metal-oxide-semiconductor (CMOS) or charge-coupled device (CCD) image sensor, configured for use in an imaging application. In some embodiments, the sensor component 514 may further include an acceleration sensor, a gyroscope sensor, a magnetic sensor, a pressure sensor, or a temperature sensor.

The communication component 516 is configured to facilitate wired or wireless communication between the terminal 500 and other devices. The terminal 500 may access a wireless network based on a communication standard, such as wireless fidelity (WiFi), 2G or 3G, or their combination. In one example, the communication component 516 receives a broadcast signal or broadcast-related information from an external broadcast management system via a broadcast channel. In one example, the communication component 516 further includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an example, the terminal 500 may be implemented by one or more of an application specific integrated circuit (ASIC), a digital signal processor (DSP), a digital signal processing device (DSPD), a programmable logic device (PLD), a field programmable gate array (FPGA), a controller, a microcontroller, a microprocessor, or other electronic elements, thus performing the method.

In the examples, a non-transitory computer-readable storage medium including instructions is further provided, such as the memory 504 including instructions. The instructions may be executed by the processor 520 of the terminal 500 to perform the above method. For example, the non-transitory computer-readable storage medium may be a read-only memory (ROM), a random-access memory (RAM), a compact disc-read-only memory (CD-ROM), a magnetic tape, a floppy disk, an optical data storage device, etc.

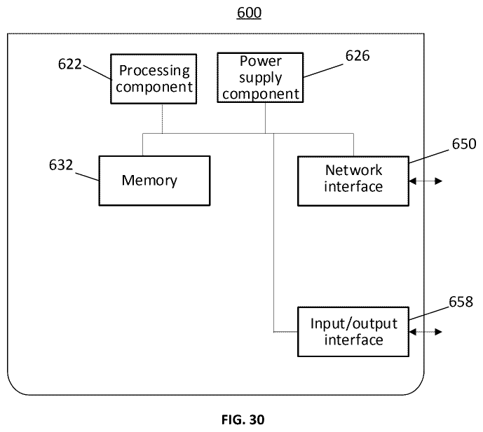

FIG. 30 is a block diagram of a structure of a core network device 600 according to an example. For example, the core network device 600 may be provided as a server. With reference to FIG. 30, the core network device 600 includes a processing component 622, which further includes one or more processors, and a memory resource represented by a memory 632 configured to store instructions executable by the processing component 622, such as applications. The application stored in the memory 632 may include one or more modules, each corresponding to a group of instructions. In addition, the processing component 622 is configured to execute the instructions to perform the method.

The core network device 600 may further include a power supply component 626 configured to perform power management for the core network device 600, a wired or wireless network interface 650 configured to connect the core network device 600 to a network, and an input/output (I/O) interface 658. The core network device 600 may operate based on an operating system stored in the memory 632, such as Windows Server™, Mac OS X™, Unix™, Linux™, FreeBSD™, or similar systems.

It may be further understood that “plurality” in the present disclosure refers to two or above, and that other quantifiers are understood similarly. When describing an association relationship of associated objects, “and/or” means that there may be three relationships. For example, A and/or B may mean that A exists alone, both A and B exist, or B exists alone. The character “/” generally indicates an “or” relationship between two associated context objects. The singular forms such as “a,” “an,” and “the” are intended to include plural forms, unless otherwise clearly stated in the context.

It may further be understood that the meanings of words such as “in response to” and “if” used in the present disclosure depend on context and actual scenarios. For example, the words “in response to” used here may be interpreted as “when,” “in a case where,” or “if.”

It may be further understood that terms such as “first” and “second” are configured to describe various information, and such information is not limited to the terms. The terms are merely configured to distinguish identical types of information from each other and do not indicate a particular order or importance. In fact, expressions such as “first” and “second” may be used interchangeably. For example, without departing from the scope of the present disclosure, first information may also be referred to as second information. Similarly, second information may also be referred to as first information.

It may be further understood that although operations are described in a specific order in the drawings in the embodiments of the present disclosure, it should not be understood that the operations are required to be executed in the specific order or serial order shown, or that all the operations shown need to be executed to obtain desired results. Under specific circumstances, multitasking and parallel processing may be advantageous.

Those skilled in the art could easily conceive of other implementation solutions of the present disclosure upon consideration of the description and the invention disclosed here. The present disclosure is intended to cover any variations, uses, or adaptive changes of the present disclosure, which follow the general principles of the present disclosure and include common general knowledge or conventional technical means in the art not disclosed in the present disclosure.

It should be understood that the present disclosure is not limited to a precise structure described above and illustrated in the accompanying drawings, and may be subjected to various modifications and changes without departing from the scope. The scope of the present disclosure is limited merely by the scope of the appended claims.

1. A communication method, performed by a user equipment (UE), the communication method comprising:
sending a first request, wherein the first request is configured to request a core network device to associate with the UE, the UE has a sensing capability, and the UE associated with the core network device is configured to perform a sensing service.

2. The communication method according to claim 1, further comprising at least one of the following:
receiving a first response message, wherein the first response message is configured to indicate that the core network device successfully associates with the UE or the core network device fails to associate with the UE;
receiving a first routing identifier, wherein the first routing identifier is configured for the UE to determine the core network device for association update with the UE, in a case where the first response message indicates that the core network device successfully associates with the UE; and the first routing identifier is configured for the UE to redetermine a core network device associated with the UE, in a case where the first response message indicates that the core network device fails to associate with the UE; or
sending a second request in a case where an interface between the UE and the core network device is in an idle state, wherein the second request is configured to request the interface between the UE and the core network device to switch from the idle state to a connected state

3. The communication method according to claim 1, wherein a first response message is determined based on a verification result of verifying the first request by the core network device, and the verification result indicates whether verification of the first request by the core network device is passed.

4. The communication method according to claim 3, wherein the verification result is determined based on at least one of subscription information or a preset rule;
the subscription information is configured to verify whether the sensing capability of the UE is correct; and
the preset rule is configured to determine whether the core network device accepts association with the UE.

5-6. (canceled)

7. The communication method according to claim 1, wherein the first request carries at least one of the following:
an association reason, wherein the association reason is configured to indicate that the UE and the core network device perform initial association, or the UE and the core network device perform association update;
the sensing capability of the UE;
location information of the UE; or
a second routing identifier, wherein the second routing identifier is configured to indicate the core network device associated with the UE.

8. A communication method, performed by a core network device, the communication method comprising:
receiving a first request, wherein the first request is configured to request the core network device to associate with a UE, the UE has a sensing capability, and the UE associated with the core network device is configured to perform a sensing service.

9. The communication method according to claim 8, further comprising:
sending a first response message, wherein the first response message is configured to indicate that the core network device successfully associates with the UE or the core network device fails to associate with the UE.

10. The communication method according to claim 8, further comprising at least one of the following:
verifying the first request to determine a verification result, wherein the verification result indicates whether verification of the first request by the core network device is passed; and
determining a first response message based on the verification result;
sending a first routing identifier, wherein the first routing identifier is configured for the UE to determine the core network device for association update with the UE, in a case where the first response message indicates that the core network device successfully associates with the UE; and the first routing identifier is configured for the UE to redetermine a core network device associated with the UE, in a case where the first response message indicates that the core network device fails to associate with the UE;
receiving a second request, wherein the second request is configured to request an interface between the UE and the core network device to switch from an idle state to a connected state; or
determining first information in a case where the core network device successfully associates with the UE, wherein the first information comprises at least one of: a tracking area identifier of the UE, a subscriber permanent identifier of the UE, the sensing capability of the UE, or location information of the UE.

11. The communication method according to claim 10, wherein verifying the first request to determine the verification result comprises:
determining the verification result based on at least one of subscription information or a preset rule, wherein
the subscription information is configured to verify whether the sensing capability of the UE is correct; and
the preset rule is configured to determine whether the core network device accepts association with the UE.

12. The communication method according to claim 11, wherein determining the verification result based on at least one of the subscription information or the preset rule comprises:
determining that the verification result indicates that verification of the first request by the core network device is passed, in a case where the subscription information verifies that the sensing capability of the UE is correct, and the preset rule is configured to determine that the core network device accepts association with the UE; or
determining that the verification result indicates that verification of the first request by the core network device is not passed, in a case where the subscription information verifies that the sensing capability of the UE is incorrect and/or the preset rule is configured to determine that the core network device does not accept association with the UE.

13. (canceled)

14. The communication method according to claim 10, wherein determining the first response message based on the verification result comprises:
determining that the first response message is configured to indicate that the core network device successfully associates with the UE, in a case where the verification result indicates that verification of the first request by the core network device is passed; or
determining that the first response message is configured to indicate that the core network device fails to associate with the UE, in a case where the verification result indicates that verification of the first request by the core network device is not passed.

15-16. (canceled)

17. The communication method according to claim 8, wherein the first request carries at least one of the following:
an association reason, wherein the association reason is configured to indicate that the UE and the core network device perform initial association, or the UE and the core network device perform association update;
the sensing capability of the UE;
location information of the UE; or
a second routing identifier, wherein the second routing identifier is configured to indicate the core network device associated with the UE.

18. The communication method according to claim 17, further comprising:
determining current location information of the UE; and
verifying the location information of the UE comprised in the first request based on the current location information.

19. (canceled)

20. A communication method, performed by a first network element, the communication method comprising:
receiving a first request; and
forwarding the first request to a second network element, wherein
the first request is configured to request a core network device to associate with a UE, the UE has a sensing capability, and the UE associated with the core network device is configured to perform a sensing service.

21. The communication method according to claim 20, further comprising at least one of the following:
sending a first response message to the UE, wherein the first response message is configured to indicate that the core network device successfully associates with the UE or the core network device fails to associate with the UE;
sending a first routing identifier to the UE, wherein the first routing identifier is configured for the UE to determine the core network device for association update with the UE, in a case where the first response message indicates that the core network device successfully associates with the UE; and the first routing identifier is configured for the UE to redetermine a core network device associated with the UE, in a case where the first response message indicates that the core network device fails to associate with the UE;
receiving a second request sent by the UE, wherein the second request is configured to request an interface between the UE and the first network element to switch to a connected state; or
sending at least one of a tracking area identifier of the UE or a subscriber permanent identifier of the UE to the second network element.

22. The communication method according to claim 21, further comprising:
verifying the first request to determine a verification result, wherein the verification result indicates whether verification of the first request by the first network element is passed; and
determining the first response message based on the verification result.

23. The communication method according to claim 22, wherein verifying the first request to determine the verification result comprises:
receiving a second response message sent by the second network element, wherein the second response message is determined by the second network element based on a preset rule, and the second response message is configured to indicate whether the second network element accepts association with the UE; and
determining the verification result based on at least one of subscription information or the second response message, wherein
the subscription information is configured to verify whether the sensing capability of the UE is correct; and/or
wherein determining the first response message based on the verification result comprises:
determining that the first response message is configured to indicate that the core network device successfully associates with the UE in a case where the verification result indicates that verification of the first request by the first network element is passed; or
determining that the first response message is configured to indicate that the core network device fails to associate with the UE in a case where the verification result indicates that verification of the first request by the first network element is not passed.

24. The communication method according to claim 23, wherein determining the verification result based on at least one of the subscription information or the second response message comprises:
determining that the verification result indicates that verification of the first request by the first network element is passed, in a case where the subscription information verifies that the sensing capability of the UE is correct, and the second response message is configured to indicate that the second network element accepts association with the UE; or
determining that the verification result indicates that verification of the first request by the first network element is not passed, in a case where the subscription information verifies that the sensing capability of the UE is incorrect, and/or the second response message is configured to indicate that the second network element does not accept association with the UE.

25-30. (canceled)

31. The communication method according to claim 20, wherein the first network element is an access and mobility management function (AMF) network element; and
the second network element is a newly added network element or a redefined network element.

32-47. (canceled)

48. A communication system, comprising:
a user equipment (UE); and
a core network device;
wherein the UE is configured to perform the communication method according to claim 1 to send the first request, wherein the first request is configured to request the core network device to associate with the UE, the UE has the sensing capability, and the UE associated with the core network device is configured to perform the sensing service; and
the core network device is configured to receive the first request; or
a communication system comprising:
a user equipment (UE);
a first network element; and
a second network element;
wherein the UE is configured to perform the communication method according to claim 1 to send the first request, wherein the first request is configured to request the core network device to associate with the UE, the UE has the sensing capability, and the UE associated with the core network device is configured to perform the sensing service;
the first network element is configured to receive the first request and to forward the first request to the second network element; and
the second network element is configured to receive the first request sent by the first network element.
